(19) United States
(12) Patent Application Publication
(10) Pub. No.: US 2026/0252863 A1
(43) Pub. Date: Aug. 27, 2026

(54) TIMING-BASED CONDUCTANCE UPDATE OF ELECTROCHEMICAL IONIC SYNAPSES

(71) Applicant: Massachusetts Institute of Technology, Cambridge, MA (US)

(72) Inventors: Bilge Yildiz Botterud, Cambridge, MA (US); Mantao Huang, Cambridge, MA (US)

(73) Assignee: Massachusetts Institute of Technology, Cambridge, MA (US)

(21) Appl. No.: 19/160,183

(22) PCT Filed: Apr. 5, 2024
(86) PCT No.: PCT/US2024/023190

§ 371 Date: Aug. 27, 2025

Related U.S. Application Data
(60) Provisional application No. 63/494,269, filed on Apr. 5, 2023.

(51) Int. Cl. G06N 3/049; G06N 3/063

(52) U.S. Cl. CPC G06N 3/049; G06N 3/063

(57) ABSTRACT

According to some embodiments, a system includes: a first neuron configured to generate a first firing waveform; a second neuron configured to generate a second firing waveform; an electrochemical ionic (EIS) synapse; and a circuit electrically connecting the first and second neurons via the EIS synapse and configured to modulate conductivity of the electrical connection provided by the EIS synapse based on relative timing of the first and second firing waveforms. The waveform shapes can be selected to implement a spike-timing-dependent plasticity (STDP) learning rule in the EIS synapse.

### CROSS-REFERENCE TO RELATED APPLICATIONS

This application claims the benefit under 35 U.S.C. § 119 of U.S. Provisional Patent Application No. 63/494,269 filed on Apr. 5, 2023, which is hereby incorporated by reference herein in its entirety.

### STATEMENT REGARDING FEDERALLY SPONSORED RESEARCH

N/A

### BACKGROUND

Deep learning artificial neural networks (ANNs) applications in a wide range of fields including image and speech recognition, natural language processing, and content generation. However, such computations are becoming prohibitively energy-intensive to perform on conventional digital computers.

### SUMMARY

Human brains function with spiking signals from billions of neurons with trillions of synaptic connections, at a power consumption of only tens of watts. Inspired by the energy-efficient spike-based biological systems, spiking neural networks (SNNs) have the potential to realize substantial enhancements in energy efficiency of computing. SNNs are spike-driven networks that use sparse and asynchronous spiking events and biologically realistic behavior of synapses and neurons for carrying out computations. These systems are adaptive, as they can perform online learning to adapt to new situations over time, while traditional neural networks need to be trained with backpropagation in separate cycles. SNNs can implement local learning rules, taking input from pre- and post-synaptic neurons (also referred to as “pre- and post-neurons”), offering the potential for powering low-energy smart devices with real-time learning. Artificial spiking neurons have also shown promise to interface with bio-chemical signals by leveraging ion-based operating mechanisms in organic materials.

One component to implementing SNN hardware is the synaptic device that emulates timing-dependent learning rules, such as spike-timing-dependent plasticity (STDP). STDP learning rules strengthen or weaken the synaptic connections between two neurons when the spiking events of the pre- and post-synaptic neuron take place in a specific temporal sequence. The synaptic weight change, or conductance change, ΔG, is a function of the relative timing, Δt, of the spiking events, and such a function is called the STDP function. One form of STDP is that the synaptic weight change is positive if the post-neuron fires shortly after the pre-neuron, and negative if the pre-neuron fires shortly after the post-neuron. The modulation strength in this form of STDP increases when the pre- and post-synaptic neurons fire close to each other, and the magnitude decreases with increasing Δt between the two firing events. STDP has been shown to enable coincidence detection, latency reduction, and supervised and unsupervised learning. STDP has diversity in the sign, symmetry, and shape of plasticity.

Heterogeneous STDP functions are also observed to occur in the same brain region, even at synapses from the same pre-synaptic neurons connecting to different post-synaptic neuron types. For example, in the dorsal cochlear nucleus, synapses that connect the parallel fiber onto fusiform cells follow different synaptic plasticity rules compared to the synapses that connect the same parallel fiber to the cartwheel cells. Such diversity and versatility of biologically observed STDP require the hardware platform to have the same flexibility to implement these different STDP forms.

Programmable resistors based on conductive filament formation, phase-change mechanism, and ferroelectricity have been explored to implement time-dependent update rules such as STDP for SNN hardware. The stochasticity of the conducting filament-forming process can cause high variability in conductance updates and unreliability of training. The phase-change mechanism has been associated with high energy consumption and conductance drift. Ferroelectric tunneling junctions (FTJs) and ferroelectric field effect transistors (FeFETs) have increased variability from the nonuniformity of the polycrystalline ferroelectric layer and stochastic switching kinetics. Variations of modulation characteristics such as the threshold voltage may be a key challenge for achieving good reliability and high performance with spiking neural networks. It is desirable to implement reliable time-dependent learning rules with low variability, low energy consumption, fast operation speed, and lean footprint.

Electrochemical ionic synapses (EIS), also known as electrochemical random-access memory (ECRAM), are three-terminal programmable resistors with conductance controlled deterministically by electrochemical charge insertion. The conductance of a channel material is modulated by ion and electron insertion/extraction, controlled by an applied electrochemical potential difference at a gate terminal with respect to the channel. Due to their low energy consumption, low variability, and deterministic charge-controlled conductivity modulation, EIS devices may enable energy-efficient analog neural networks.

EIS devices have strong nonlinear response to applied voltage. This arises from the nonlinear electric field dependence of ion transport and interfacial charge transfer kinetics in EIS, as well as the nonlinear dependence of electronic conductivity on the concentration of ions and electrons inserted in certain channel materials. This nonlinear kinetics of EIS presents an opportunity to achieve timing-dependent weight updates in a synaptic device as needed for STDP and SNNs.

Disclosed structures and techniques leverage the intrinsic nonlinearity of EIS devices to be used to achieve various forms of STDP learning rules in an energy-efficient and controllable manner. Disclosed embodiments implement different forms of the STDP function by a linear superposition of appropriately designed pre- and post-synaptic neuron signals (also referred to herein as “spikes,” “pulses,” “firing signals,” “firing waveforms,” and “voltage waveforms”) at the gate of EIS. Disclosed embodiments can be applied to implement heterogeneous STDP rules within an array to capture different learning rules in the same system. For example, it is shown herein that the timing-dependent weight update allows heterogeneous choices of STDP function shapes in synapses from a single neuron connecting to different post-synaptic neurons. Response timescales can be controlled from milliseconds down to nanoseconds, and with low variability, lower than other STDP attempts in the field. The general approach described herein leverages the intrinsic nonlinearities of the EIS device, without the need for transistors at each synapse, so the system has reduced footprint and fabrication complexity. This disclosure demonstrates how EIS can serve as programmable synapses to enable reliable hardware implementations of SNN with high energy efficiency and high throughput. The STDP resulting from EIS has lower variability than other hardware STDP implementations, due to the deterministic and uniform insertion of charge in the tunable channel material. Disclosed embodiments leverage ion and charge transfer dynamics in EIS to enable bio-plausible synapses for SNN hardware with high energy efficiency and throughput.

Embodiments of the present disclosure include a local circuit for connecting an EIS to pre- and post-neurons, a crossbar array for interconnecting many such neurons, and a technique for the programming of conductance values of a crossbar array of electrochemical ionic synapses that implements timing-based weight updates.

According to one aspect of the disclosure, a system includes: a first neuron configured to generate a first firing waveform; a second neuron configured to generate a second firing waveform; an electrochemical ionic (EIS) synapse; and a circuit electrically connecting the first and second neurons via the EIS synapse and configured to modulate conductivity of the electrical connection provided by the EIS synapse based on relative timing of the first and second firing waveforms.

In some embodiments, the circuit can be configured to generate a linear superposition of the first and second firing waveforms. In some embodiments, the first firing waveform can have a first shape and the second firing waveform can have a second shape different from the first shape. In some embodiments, the first shape and the second shape can have similar magnitude and opposite polarity.

In some embodiments, the first shape and the second shape can be selected to implement a spike-timing-dependent plasticity (STDP) learning rule in the EIS synapse. In some embodiments, durations of the first and second waveforms can also be selected to implement the STDP learning rule. In some embodiments, the STDP learning rule may correspond to at least one of: an antisymmetric STDP form; a long-term potentiation only STDP form; and a bidirectional symmetric STDP form.

In some embodiments, the EIS synapse can include a first terminal connected to a first output of the first neuron, a second terminal connected to an input of the second neuron, and a gate terminal connected to both a second output of the first neuron and an output of the second neuron. In some embodiments, the circuit can include voltage divider connecting the second output of the first neuron and the output of the second neuron to the gate terminal of the EIS synapse.

In some embodiments, the EIS synapse can include: an ion reservoir storing ions to be released upon application of an electrical stimulus; a channel comprised of one or more materials with tunable electrical conductivity determined by an ion concentration therein; and an electrolyte disposed between the reservoir and the channel and configured to conduct ions and insulate electrons. In some embodiments, the first neuron can be configured to generate the first firing waveform according to a leaky integrate-and-fire (LIF) protocol.

In some embodiments, the first neuron can be one of a plurality of pre-neurons and the second neuron can be one of a plurality of post-neurons, wherein the pre- and post-neurons are connected in a crossbar array. In some embodiments, the pre- and post-neurons can be connected to form a spiking neural network (SNN). In some embodiments, the pre- and post-neurons are connected to form an artificial neural network (ANN).

According to one aspect of the disclosure, a neural network includes: a plurality of pre-neurons; a plurality of post-neurons; and a crossbar array having a plurality of electrochemical ionic (EIS) synapses and corresponding local circuits, wherein each of the plurality of EIS synapses and corresponding local circuits electrically connects one of the plurality of pre-neurons to one of the plurality of post-neurons, wherein the local circuits are configured to modulate conductivity of the electrical connection provided by the EIS synapses based on relative timing of pulses generated by the pre-neuron and pulses generated by the post-neuron. The neurons, EIS synapses, and local circuits can include any of the aforementioned embodiments.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1A is a schematic illustration of an EIS device.

FIG. 1B is cross-sectional view of an EIS device illustrating dimensions and materials that may be used in fabrication, according to some embodiments.

FIGS. 2A-C are plots illustrating nonlinear response of an EIS device to applied gate voltage.

FIG. 3A is a diagram illustrating a local circuit for linear superposition of voltage signals from the pre- and post-synaptic neurons, according to some embodiments.

FIG. 3B is a pair of graphs showing pre- and post-neuron firing waveforms that can be used to achieve a particular spike-timing-dependent plasticity (STDP), according to some embodiments.

FIG. 3C is a series of graphs showing the firing waveforms of FIG. 3B at the gate terminal of the local circuit of FIG. 3A for different relative firing times (Δt).

FIG. 3D is a plot showing EIS conductance change (ΔG) after the firing of both the pre- and post-synaptic neurons, as a function of the relative timing of firing (Δt).

FIGS. 4A-D illustrate pre- and post-neuron firing waveforms for implementing different STDP forms, according to some embodiments.

FIG. 5A is a schematic diagram showing a configuration of neurons and EIS devices to implement different STDP forms (heterogenous STDP), according to some embodiments.

FIG. 5B is a pair of plots showing resulting STDP forms at the EIS devices (synapses) of FIG. 5A.

FIG. 5C is a diagram of a circuit for emulating dopamine-modulated STDP scales the pre- and post-synaptic neuron signals that are combined to serve as VG of an EIS device, according to some embodiments.

FIG. 5D is a series of graphs showing STDP forms as a function of a scaling factor of the post-synaptic neuron (Apost).

FIG. 5E is a diagram showing a circuit for adding a dopamine signal to pre- and post-neuron firing waveforms, according to some embodiments.

FIG. 5F is a diagram showing a circuit to implement the dopamine-modulated STDP, according to some embodiments.

FIGS. 6A-C illustrate how disclosed structures and techniques can be used to implement STDP with timescales from milliseconds down to nanoseconds.

FIG. 6D is a plot showing a comparison of variability and programming timescale for synaptic devices implementing STDP.

FIG. 7 is a block diagram of a neuron that may be connected to other neurons using disclosed EIS devices and techniques.

FIG. 8A is a schematic diagram showing pre- and post-neurons fully connected using an EIS circuit, according to some embodiments.

FIG. 8B is a schematic diagram of a crossbar architecture that can be used to interconnect many pre- and post-neurons, according to some embodiments.

FIG. 9 is a schematic diagraming showing an implementation of a neuron, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

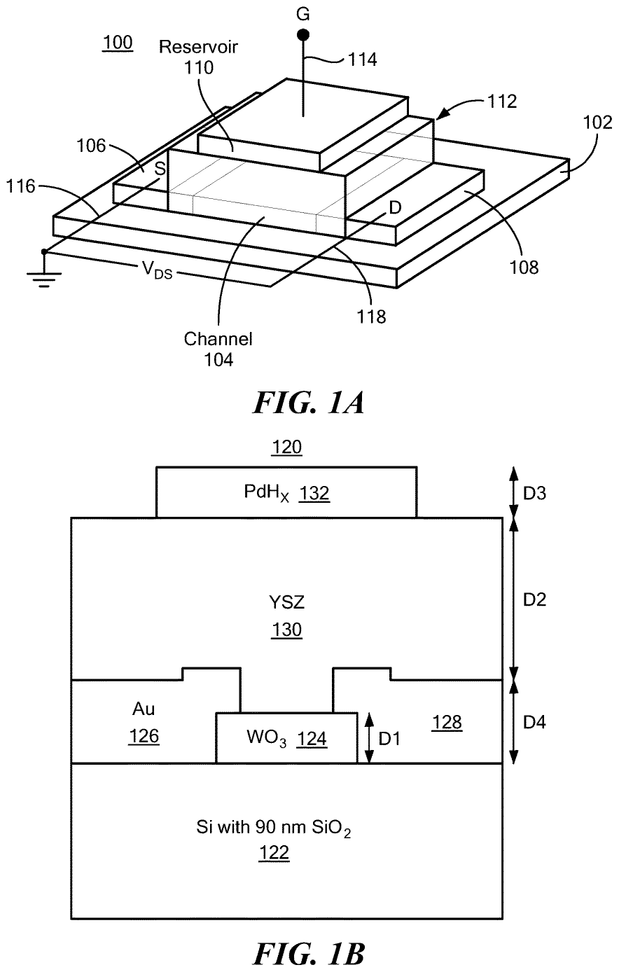

Turning to FIG. 1A, the operations of electrochemical ionic synapses (EISs) are based on shuffling of dopants across active device layers that control the conductance of a channel in a three-terminal configuration. As shown in FIG. 1A, an EIS device 100 can include a channel layer comprising a channel region 104 surrounded by contact regions 106, 108, all disposed on a substrate 102. The device 100 can further include a reservoir layer 110 disposed above the channel region 106, separated by an electrolyte layer 112 (e.g., a layer of solid-state electrolyte).

Reservoir layer 110 is configured to store ions (e.g., protons) that are ready to be released upon the application of an electrical stimulus. Electrolyte layer 112, sandwiched between reservoir layer 110 and channel region 106, is configured to conduct ions such as H+, Li+ and O2− and insulate electrons. Channel region 106 can be made of materials with tunable electronic conductivity that is determined by the ion concentration in it.

Three electrodes are placed for the operation of an EIS: the gate terminal 114 (G) contacting the reservoir layer 110, and a source terminal 116 (S) and a drain terminal 118 (D) in contact with contact regions 106 and 108, respectively of the channel layer. The conductance of the channel region 104 can be read out by measuring the current from a small voltage (V_{DS}) applied across source terminal 116 and drain terminal 118.

FIG. 1B shows dimensions and materials that may be used in fabrication of EIS devices, according to some embodiments. An illustrative EIS device 120 includes a substrate 122, a channel region 124 surrounded by a source contact 126 and a drain contact 128, and an electrolyte layer 130, and a top layer 132.

Channel region 124 can be formed from WO₃ having a thickness D1 (e.g., 10 nm thick), electrolyte layer 130 can be formed from thick yttria-stabilized zirconia (YSZ) having a thickness D2 (e.g., 7-14 nm), and top layer 132 can be formed from Pd having a thickness D3 (e.g., 15 nm), providing a hydrogen reservoir layer and the gate. Source and drain contacts 126, 128 are made of Au with a Cr adhesion layer, connecting to the side of channel region 124. Channel region 124 can have lateral dimensions between 3 μm to 40 μm for the width and length, for example.

Channel region 124 can have a tunable electronic conductance that is determined by the proton concentration in it. The YSZ electrolyte layer 130 can be fully oxidized. For example, the Zr and Y can have valences of +4 and +3, respectively. The YSZ electrolyte layer 130 can be largely amorphous, consistent with a film deposited at room temperature. The fully oxidized YSZ electrolyte is insulating for electrons, but the amorphous and likely nanoporous nature of it makes it conductive to protons through absorbed —OH groups. The Pd top layer 132 becomes a hydrogen reservoir in the form of PdHₓ, when exposed to hydrogen-containing forming-gas.

The application of a gate voltage that is higher than the open circuit voltage (~−0.3 V-0 V, depending on the proton concentration in the WO₃ channel region 124) oxidizes hydrogen in the PdHₓ top layer 132 and drives the protons from the reservoir through the electrolyte layer 130 into the channel region 124 with electrons flowing through the external circuit from the gate to the channel. The electrons inserted into the WO₃ along with the protons, lead to the filling of in-gap states of WO₃ and increase its electronic conductivity. The application of a gate voltage lower than the open circuit voltage reverses the process. Because of the small size of the proton and the high sensitivity of the WO₃ electronic conductivity to hydrogen concentration, the device allows for high-speed (ns regime) modulation and high energy efficiency.

The inventors have shown that an EIS device similar to that illustrated in FIGS. 1A and 1B can be programmed reliably with low energy consumption, e.g., close to 20 aJ per programming pulse for the proton transfer during the peak voltage of the pulses, with order of fJ per pulse including the charging and discharging transients. Using such protonic EIS devices, the nonlinearity of the conductance change can be experimentally quantified, and that nonlinearity can be leveraged to achieve timing-based conductance updates emulating different STDP forms, as discussed in detail below.

In some embodiments, an EIS device can be fabricated on Si substrates with 90 nm thermal SiO₂ oxide. First, the channel can be patterned using electron-beam lithography with polymethyl methacrylate (PMMA) resist. The WO₃ channel (10 nm thick) can be grown by reactive sputtering using a W target in a gas environment with an Ar:O₂ ratio of 9.3:2.7 at 3 mTorr at room temperature, followed by liftoff. The source and drain contacts can be patterned and deposited by electron-beam lithography and electron-beam evaporation of Cr (e.g., 5 nm of Cr) and Au having a thickness D4 (e.g., 35 nm), followed by liftoff. The YSZ solid-state electrolyte (e.g., 14 nm or 7 nm thick) can be grown by RF sputtering from a YSZ (8 mol % yttrium oxide doped zirconium oxide) target with Ar:O₂ ratio of 15:4 at 3 mTorr at room temperature, followed by photolithography and ion milling. Finally, the Pd reservoir layer can be patterned and deposited with electron-beam lithography, and electron-beam evaporation followed by liftoff. The Pd layer becomes PdH, when placed in the hydrogen forming gas environment.

Various other materials and dimensions may be used to form an EIS device.

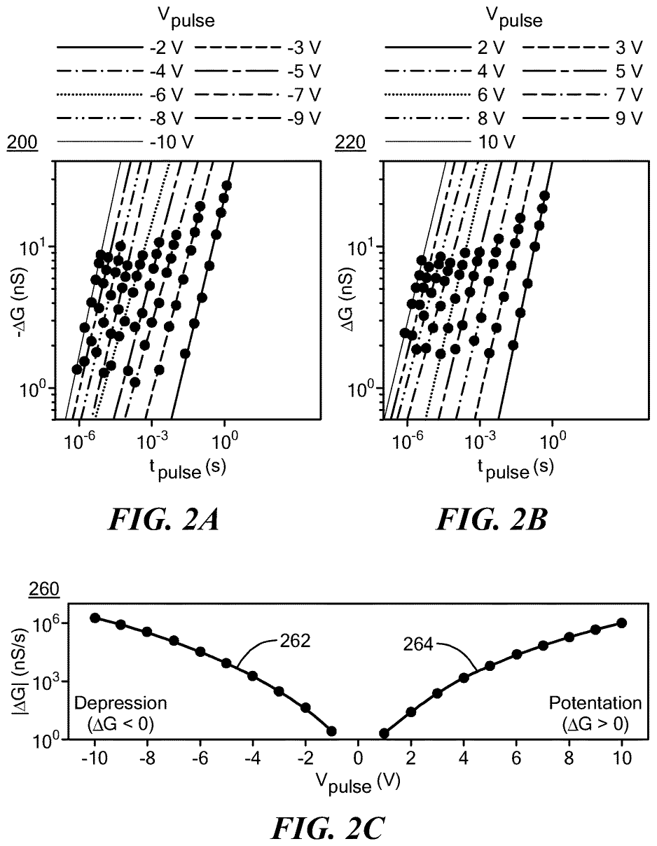

Turning to FIGS. 2A-C, the conductance change in an EIS has a strongly nonlinear dependence on the gate voltage when the gate voltage is away from the open circuit potential. This nonlinear dependence is a result of nonlinear ion transport through the electrolyte, nonlinear reaction kinetics at the interfaces as well as nonlinear dependence of the conductance of the channel on the inserted ion concentration. When a strong electric field is present across the electrolyte, the energy barrier for ion conduction is lowered, giving rise to a field-enhanced ionic conductivity, σ.

The dependence of σ on the electric field, E through the electrolyte is approximately proportional to

$$sinh ( \frac{q {l}_{x} E}{2 {k}_{B} T} ) ,$$

where q is the ion charge, lₓ is the hopping distance, k_{B} is the Boltzmann constant, and T is temperature. Similarly, the reaction kinetics at the interfaces can be described by the Butler-Volmer equation,

$$j = {j}_{0} ( {e}^{\frac{α zF {V}_{i}}{R T}} - {e}^{\frac{- ( 1 - α ) z F {V}_{t}}{R T}} ) ,$$

where j is the reaction current density, j₀ is the exchange current density, α is the charge transfer coefficient for the interface, F is Faraday constant, R is the ideal gas constant, z is the ion charge number, and Vᵢ is the overpotential at the interface. When α is 0.5, the expression of j simplifies also to a sinh dependence on the local voltage such that

$$j ∝ sinh \frac{z F {V}_{i}}{2 R T} .$$

This nonlinear voltage dependence has been experimentally observed for EIS devices with various ions. The sinh relation has been used to explain and model the voltage dependence of conductance modulation for EIS devices.

FIGS. 2A and 2B show the conductance change of an EIS device as a function of pulse duration (tₚᵤₗₛₑ) and pulse voltage (Vₚᵤₗₛₑ) applied to the gate terminal. These graphs illustrate conductance change for an EIS device having an YSZ electrolyte thickness (t_{YSZ}) of 14 nm, although nonlinear can be exhibited for other types of materials and other material dimensions.

Plot 200 of FIG. 2A shows conductance change for negative pulse voltages (Vₚᵤₗₛₑ between −2 V and −10 V) and plot 220 of FIG. 2B shows conductance change for positive pulse voltages (Vₚᵤₗₛₑ between +2 V and +10 V). The horizontal axes correspond to pulse duration (tₚᵤₗₛₑ) and the vertical axes correspond to pulse voltage (Vₚᵤₗₛₑ), all having logarithmic scales. Dashed lines in FIGS. 2A and 2B are linear fits of the log-log plot of ΔG versus tₚᵤₗₛₑ.

As can be seen, for the same Vₚᵤₗₛₑ, the change in conductance achieved in each pulse, ΔG, scales nearly linearly with tₚᵤₗₛₑ, with small deviations. However, ΔG gets exponentially larger for higher Vₚᵤₗₛₑ. For example, an increase of Vₚᵤₗₛₑ from 2 V to 4 V speeds up (requires a lower value of tₚᵤₗₛₑ) conductance modulation by ~60 times, and an increase from 2 V to 6 V speeds up by ~1000 times.

FIG. 2C shows the rate of conductance change (Δ\dot{ }G) as a function of pulse voltage (Vₚᵤₗₛₑ). Plot 260 can be obtained from the intersect of the linear fit on the log-log plots of FIGS. 2A and 2B. In more detail, curve 262 of FIG. 2C can be obtained from the data plotted in FIG. 2A and curve 264 of FIG. 2C can be obtained from the data plotted in FIG. 2B. Nonlinear dependence of Δ\dot{ }G on V_{G} such as illustrated in FIG. 2C enables the timing-based update of conductance at the EIS, as described further below.

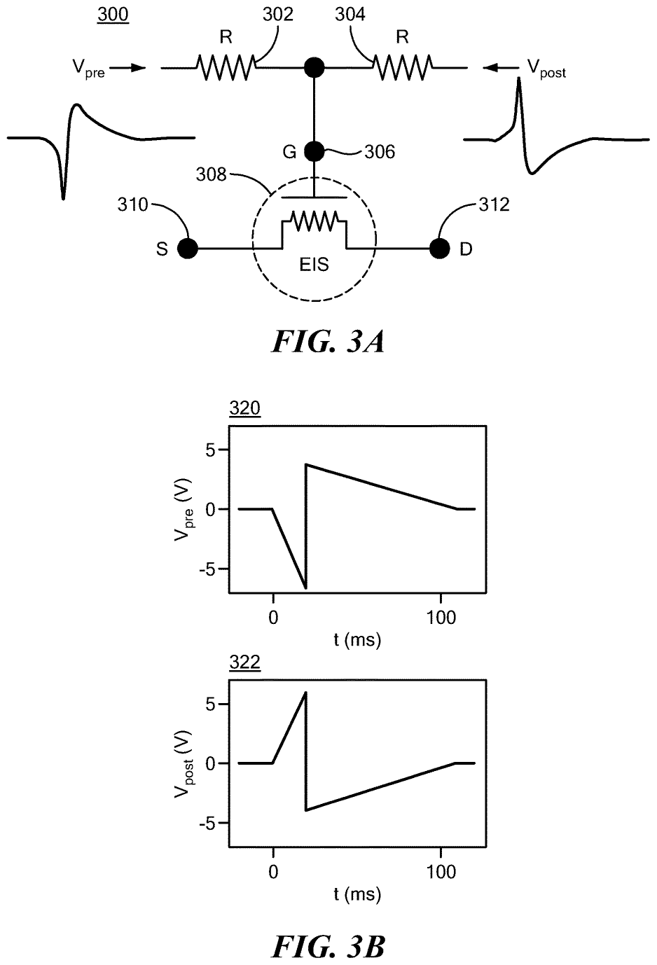

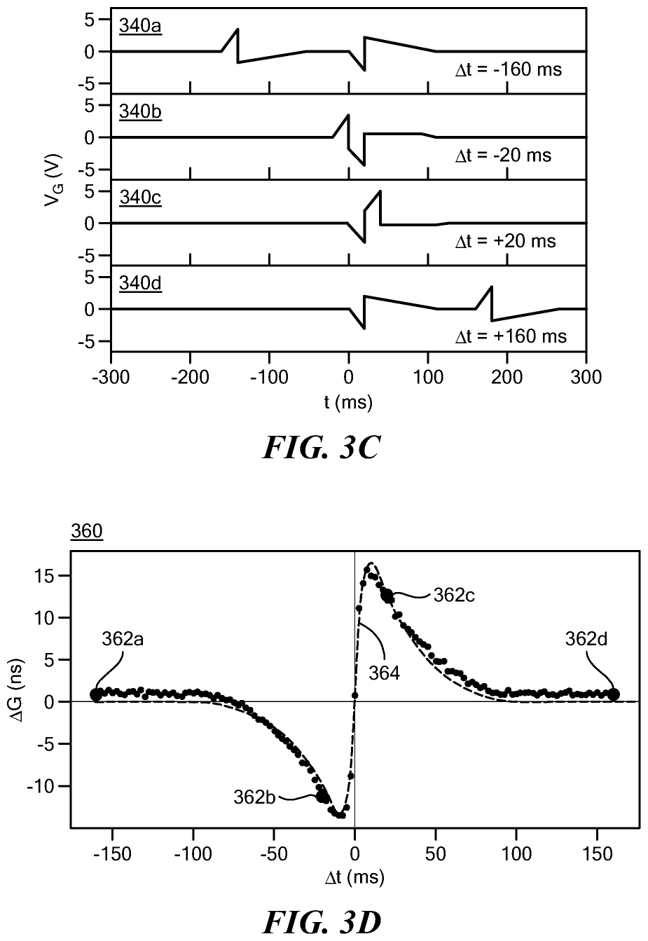

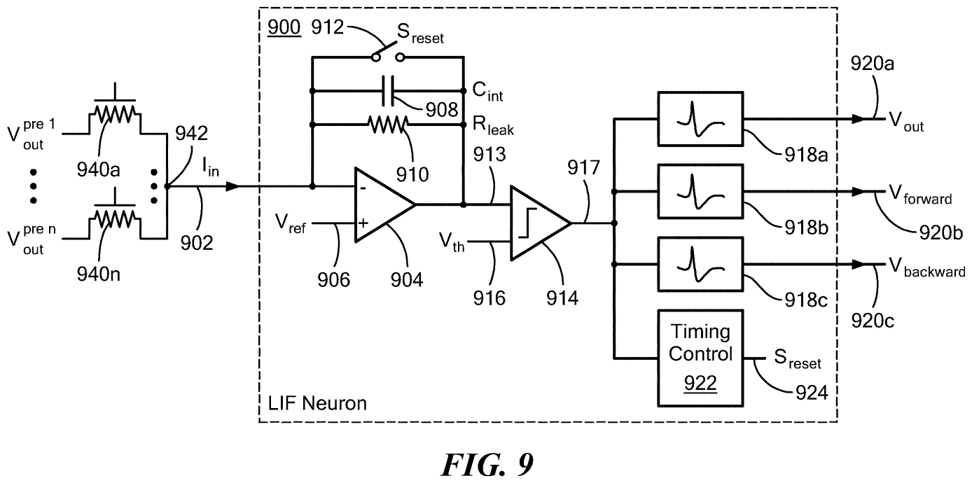

Turning to FIG. 3A, to implement timing-dependent learning rules with EIS, embodiments of the present disclosure apply a linear superposition of voltage waveforms (or “firing waveforms”) generated by pre- and post-synaptic neurons to the gate of the EIS. The time dependence of the pre- and post-synaptic neuron firing waveforms can be designed to target different forms of STDP. Examples of neurons that can be configured to generate such designed waveforms are described below in the context of FIG. 9.

FIG. 3A shows an example of a local circuit 300 for implementing the linear superposition in an energy-efficient manner. It should be appreciated that the local circuit implementation shown in FIG. 3A is merely one example, and that other circuits can be used. For example, linear superposition of the pre- and the post-synaptic spikes can be implemented by applying one of the pre- or post-synaptic voltage waveforms on the EIS gate, and the other on the EIS source/drain, so that the voltage drop, V_{GS}, is the difference between the two waveforms. A voltage divider circuit may be used in applications where it is important not to strongly biasing the source and drain, which could create an uneven proton distribution across the channel. In addition, it is appreciated herein that energy consumption may be lower with the voltage divider circuit, if the resistors are chosen to be larger than the channel resistance.

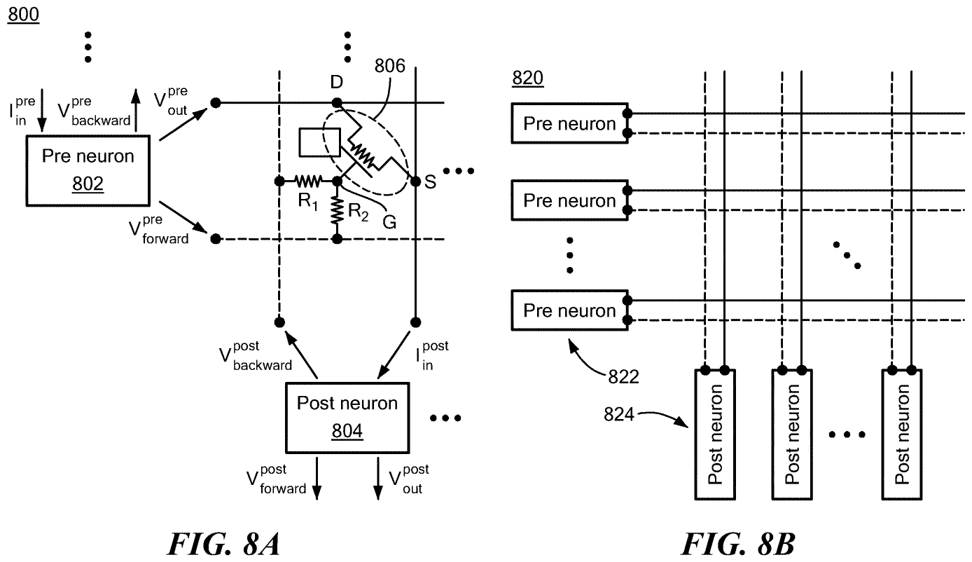

Local circuit 300 comprises a voltage divider comprising series-connected resistors 302, 304. A first resistor 302 can be connected between a pre-neuron (not shown) and a gate terminal 306 of an EIS device 308. A second resistor 304 can be connected between a post-neuron (not shown) and the EIS gate terminal 306. In some cases, resistors 302, 304 can be selected to have the same resistance, denoted R. The voltage divider is formed across the voltage waveforms from the pre-synaptic neuron (Vₚᵣₑ) and the post-synaptic neuron (Vₚₒₛₜ). The EIS source terminal 310 and drain terminal 312 can separately be connected to the pre- and post-neurons, respectively, such as illustrated in FIG. 8A.

For the voltage divider to produce the desired linear superposition of the voltages, the resistance (R) of the resistors 302, 304 can be selected to be much smaller (e.g., at least 10× smaller) than the gate resistance of the EIS device 308. The requirement is trivial to satisfy because the gate resistance of an EIS device may very high (e.g., more than 10 GΩ for a submicron device) because the electrolyte is electronically insulating.

The capacitance of the gate needs to be considered for the operation speed of the circuit. Evaluated here is the time constant for a scaled-down device with an area of 30 nm×30 nm, and an electrolyte thickness of 7 nm. The capacitance of the device can be calculated by:

$$C = \frac{ϵ A}{d} = \frac{k {ϵ}_{0} A}{d} = \frac{27 \times 8.854 \times 1 {0}^{- 12} F / m \times {( 30 nm )}^{2}}{7 nm} = 3.07 \times 1 {0}^{- 17} F$$

By choosing R=100 MΩ for the resistor, the time constant is calculated to be

$$τ = ( \frac{R}{2} ) C = 3. 07 \times 1 {0}^{- 17} \times 1 {0}^{8} \approx 1.5 ns .$$

R/2 is used as the resistance component as the two resistors are in parallel when charging/discharging the capacitor. It is possible to get a shorter time constant by choosing a lower resistance value. However, reducing the resistance value will increase energy consumption as we discuss herein. Therefore, in some embodiments, the resistance value can be chosen to achieve a balance between the energy consumption and the response speed. The choice of R=100 MΩ is optimized for achieving STDP in a time scale of tens of nanoseconds.

The resulting voltage waveform (V_{G}) at EIS gate terminal 308 depends on the relative timing (Δt) of the firing of the pre- and the post-synaptic neurons. Here, define Δt=tₚₒₛₜ−tₚᵣₑ, where tₚₒₛₜ and tₚᵣₑ are the times when the post- and pre-synaptic neuron fire, respectively. Δt is positive when the post-neuron fires after the pre-neuron. With an R value sufficiently small, the gate voltage can be approximated by the formula V_{G}=(Vₚᵣₑ+Vₚₒₛₜ)/2. The voltage divider structure does not consume energy when the neurons are in the resting state, and energy is only consumed during spiking events.

FIGS. 3B-D show an example of timing-based conductance modulation of a single EIS synapse to implement an STDP learning rule. In this example, a common STDP form is implemented, where the conductance of a synapse increases for Δt>0 and decreases for Δt<0. To achieve this form of STDP, which is illustrated by plot 360 of FIG. 3D, the Vₚᵣₑ and Vₚₒₛₜ waveforms can be selected to match (or be similar to) waveforms 320 and 322, respectively, of FIG. 3B. In more detail, the pre- and post-neurons can be configured to generate firing waveforms similar to those shown in FIG. 3B.

In this example, Vₚᵣₑ and Vₚₒₛₜ waveforms 320, 322 have similar magnitude (voltages that are within 1%, 2%, 5%, 10%, etc.) over time, but of opposite polarity. The Vₚᵣₑ and Vₚₒₛₜ waveforms 320, 322 are designed such that they do not induce a large conductance change of the synapse if they fire alone. The self-compensating characteristic of Vₚᵣₑ and Vₚₒₛₜ waveforms ensures there is a significant net conductance change only when these two signals fire close enough and overlap in time (i.e., the absolute value of Δt is close to zero, as illustrated in FIG. 3D). More generally, the shape of the Vₚᵣₑ and Vₚₒₛₜ waveforms can be selected to enable various targeted STDP forms, and an approach for designing such waveforms is described in detail below.

Depending on the timing of the firing of the pre- and post-synaptic neurons, the gate voltage (V_{G} (t)=(Vₚᵣₑ (t)+Vₚₒₛₜ (t))/2) takes different waveforms for different Δt values, as shown by graphs 340a-d FIG. 3C. In more detail, graphs 340a, 340b, 340c, and 340d shows V_{G}(t) with Δt equal to −160 ms, −20 ms, +20 ms, and +160 ms, respectively, using the pre- and post-neuron firing waveforms 320, 322 of FIG. 3B.

In some embodiments, the superimposed waveforms can be calculated and applied to the EIS gate terminal 306 using a function generator (e.g., a SIGLENT 2000× function generator). After the V_{G}(t) waveform is complete, 0 V can be applied to the EIS device 308 as a rest potential, rather than open circuit, for practical operation.

Most of the conductance change in the EIS device 308 takes place right after the spiking event, although the ΔG quantified here is the conductance different between right before and 20 s after the pre-synaptic neuron signal fires. (The delay time to read does not reflect the timescale of the conductance modulation).

The resulting ΔG as a function of relative timing, Δt is shown in FIG. 3D, with points (e.g., points 362a-d) corresponding to experimental data and dashed curve 364 corresponding to the modeled and calculated ΔG. The ΔG can be calculated as the integration of conductance change rate at each time segment multiplied by a scaling factor of 0.7, for example. The four labeled points 362a, 362b, 362c, and 362d in FIG. 3D correspond Δt being equal to −160 ms, −20 ms, +20 ms, and +160 ms, respectively.

As shown by FIG. 3D, the amplitude of modulation is highest when the pre- and post-synaptic neurons fire close to each other (the absolute value of Δt is small). It is appreciated herein that the resulting behavior emulates the canonical STDP behavior seen in biological neural circuits. Various other STDP forms and behaviors can be achieved using the general structures and techniques disclosed herein.

The shape of a timing-dependent conductance change curve, such as shown in FIG. 3D, can be qualitatively explained by the nonlinear dependence of the channel conductance change on the gate voltage. Because the conductance change is much greater at higher voltage, as explained above from the nonlinearity of the EIS, the conductance change from the portion of the V_{G}(t) waveform with a high voltage amplitude dominates. When Δt is close to zero (e.g. Δt=20 ms, and Δt=−20 ms in FIG. 3C), the conductance change is dominated by the large positive or negative voltage peak. When Δt is farther away from zero, the peak voltage becomes smaller, and the net conductance change becomes much smaller.

The time-dependent response of the EIS can be modeled to predict the learning curve from different V_{G}(t) waveforms, and to design Vₚᵣₑ(t) and Vₚₒₛₜ(t) waveforms for an STDP form of interest. The STDP function can be calculated using the nonlinear dependence of conductance change on the gate voltage of EIS devices. If the spiking events of the pre- and the post-synaptic neuron take place at the same time, at t=0, the waveforms are denoted as

$${V}_{p r e}^{0} ( t ) and {V}_{p o s t}^{0} ( t )$$

(such as nose shown in FIG. 3B).

If the post-neuron spikes with a delay Δt relative to the pre-neuron, then

$${V}_{p o s t} ( t ) = {V}_{p o s t}^{0} ( t - Δ t ) and {V}_{p r e} ( t ) = {V}_{p r e}^{0} ( t ) .$$

The gate voltage waveform is therefore:

$${V}_{G} ( t ) = \frac{{V}_{p r e} + {V}_{p o s t}}{2} = \frac{{V}_{p r e}^{0} ( t ) + {V}_{post}^{0} ( t - Δ t )}{2} .$$

Assuming there is no interaction between the time segments, the change of conductance of the EIS can be calculated as an integral of the rate of conductance change for each time segment:

$$Δ G = \int Δ \dot{G} ( {V}_{G} ( t ) ) d t = \int Δ \dot{G} ( \frac{{V}_{p r e}^{0} ( t ) + {V}_{p o s t}^{0} ( t - Δ t )}{2} ) d t \qquad ( Equation 1 )$$

where ΔĠ(V_{G}) is the rate of conductance change that depends on the gate voltage, V_{G}, and the limit of integration covers the whole period of the two spiking events.

The rate of conductance change ΔĠ(V_{G}) can be interpolated from experimentally measured data, such as the data plotted in FIG. 2C. The calculated time-dependence of the STDP curves (dashed curve 364 in FIG. 3D) shows good agreement with the experimentally measured STDP from the EIS devices.

After the conductance change from all Δt values is calculated through the integration in Equation (1), they can be multiplied by a common factor (e.g., a factor between 0.5 to 0.7). This may be done to account for complex dynamics of EIS, such that the modeled conductance peak amplitude matches the experimental data. For a given combination of

$${V}_{p r e}^{0} ( t ) and {V}_{p o s t}^{0} ( t ) ,$$

a curtain scaling factor can be used. It is appreciated that, in some cases, the conductance change of EIS cannot be treated as a simple integration over each time segment assumed to be non-interacting, also seen in FIGS. 2A and 2B. The behavior may be due to the intrinsic dynamics of the EIS devices, including the capacitive processes such as the accumulation of ions at the interfaces.

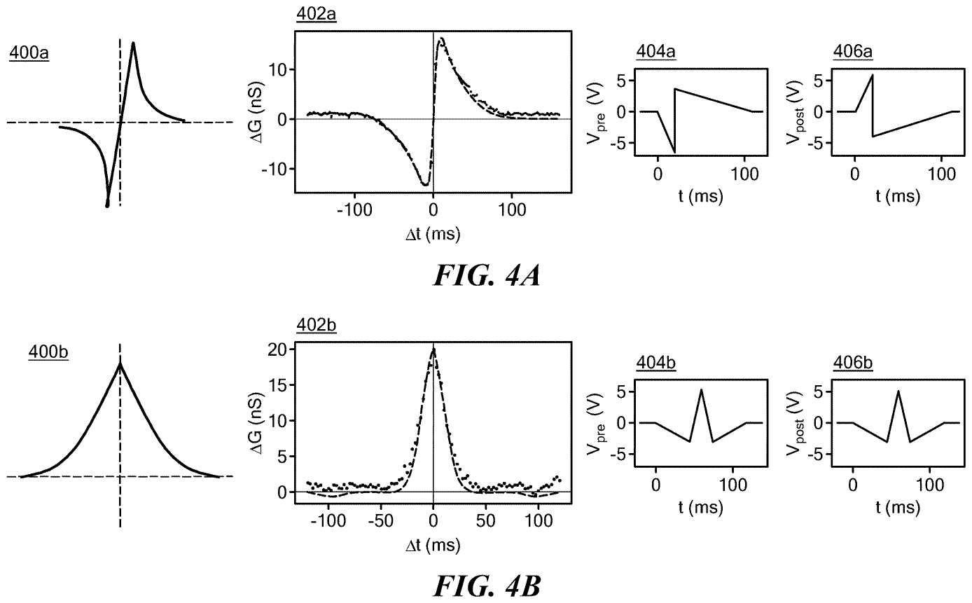

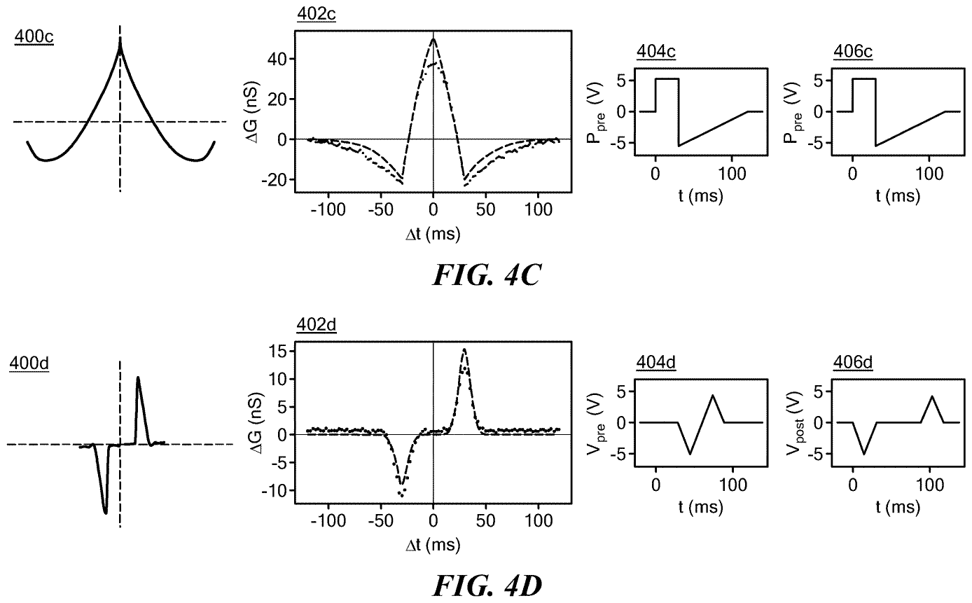

Turning to FIGS. 4A-D, the diversity and versatility of biologically observed STDP forms can demand high flexibility on the part of the hardware. Demonstrated are four STDP forms that can be generated by changing the pre- and post-neuron firing waveforms (Vₚᵣₑ and Vₚₒₛₜ) using, for example, the EIS local circuit of FIG. 3A. The STDP forms of FIGS. 4A-4D correspond to four different STDP forms that have been observed in a brain.

FIG. 4A-D shows a four STDP forms 400a-d observed in the brain, respective plots 402a-d showing ΔG versus Δt measurements made using the EIS local circuit, and respective the pre- and post-neuron firing waveforms 404a-d, 406a-d (Vₚᵣₑ and Vₚₒₛₜ) used to produce said measurements. The demonstrated STDP forms include: the conventional antisymmetric STDP form characterized in hippocampal cultures (FIG. 4A), long-term potentiation only STDP form found at CA3-CA1 hippocampal synapses (FIG. 4B), bidirectional symmetric STDP form found in GABAergic hippocampal synapses (FIG. 4C) and antisymmetric STDP form with a region of no plasticity in a temporal range near Δt=0, observed in inhibitory synapses in the entorhinal cortex (FIG. 4D).

The dashed lines in plots 402a-d show the simulated STDP (using the approach described above), which are in good agreement with the experimentally measured STDP data. The agreement between the modeled and experimental results indicate that the structures and techniques described herein provide reliable and predictable timing-dependent conductance update.

In biological neurons, the electrical signals that correspond to spiking events generally take similar forms although they can produce different STDP functions (400a-d). This is in contrast to the very different Vₚᵣₑ and Vₚₒₛₜ waveforms (e.g., 404a-d, 406a-d) used here to capture different STDP forms. The origin of biological synapses showing different STDP functions from similar electrical signals has been attributed to chemical signals such as calcium concentration transients. It may be difficult to capture the details of chemistry at each synapse since the EIS device materials and ions used are the same for each STDP form. Thus, the general concepts described herein may be used to select the Vₚᵣₑ and Vₚₒₛₜ waveforms used to represent a convolution of the spiking electrical signal and the local chemistry and molecular pathways that the STDP originates from.

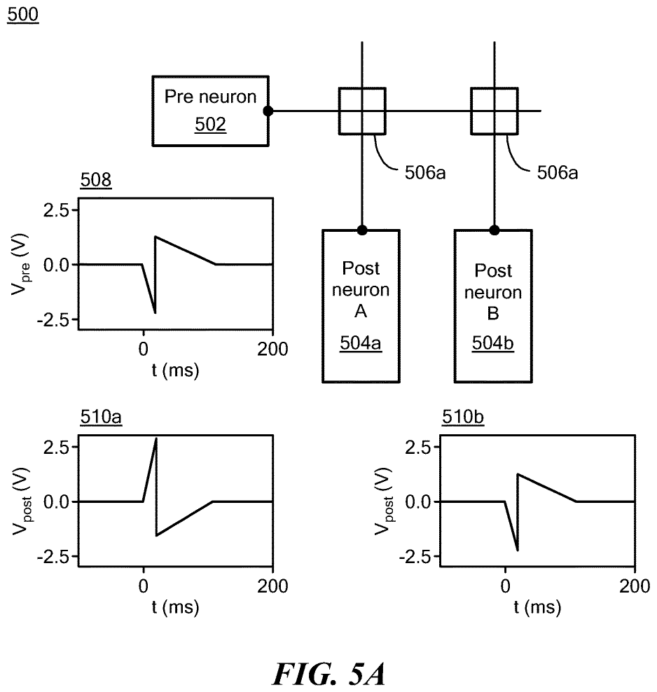

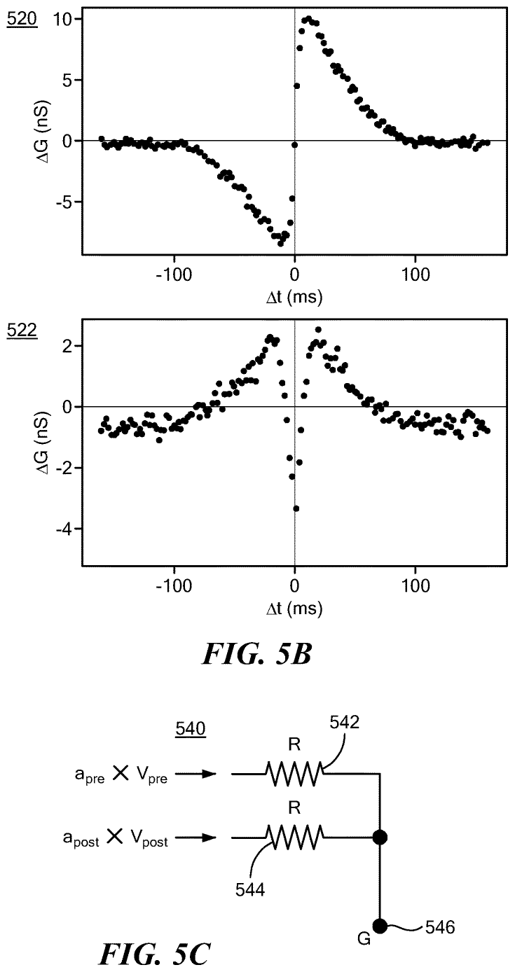

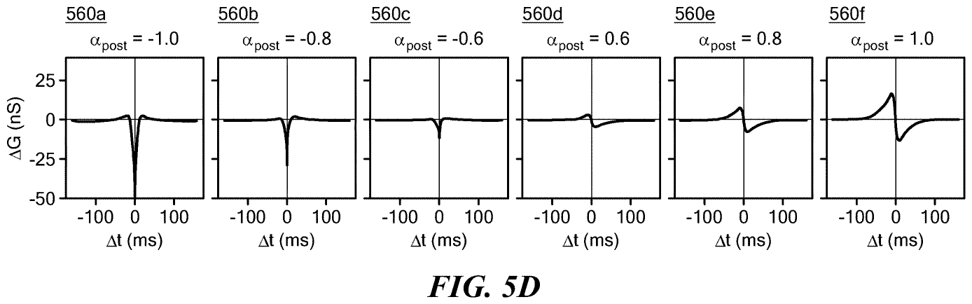

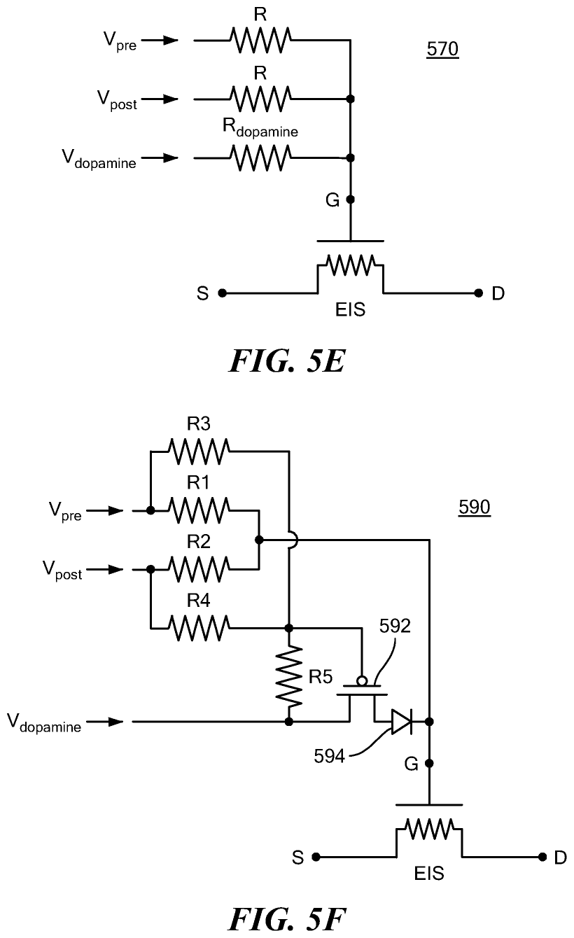

Turning to FIG. 5A, in biological systems, different STDP forms take place at synapses connecting the same pre-synaptic neurons to different post-synaptic neuron types. In addition, the STDP form can be altered by neuromodulators including dopamine or acetylcholine. The structures and techniques disclosed herein can utilize EIS devices to emulate such behaviors.

An illustrative configuration 500 includes a pre-neuron 502 connected to two post-neurons 504a, 504b via respective EIS devices 506a, 506b (or “synapses”). In this configuration, the pre-synaptic firing waveform (Vₚᵣₑ) is shared by the two EIS devices 506a, 506b, but these synapses can receive different post-synaptic firing waveforms (Vₚₒₛₜ) from different post-synaptic neurons 504a, 504b. An example of a shared pre-synaptic firing waveform is illustrated by graph 508. Examples of different post-synaptic firing waveforms are illustrated by graphs 510a, 510b.

With configuration 500, the linear superposition of the Vₚᵣₑ and Vₚₒₛₜ is different in symmetry and shape on two different EIS devices 506a, 506b. As a result, different STDP forms (or “learning rules”) can be generated for the two synapses, shown in FIG. 5B. In more detail, plot 520 shows a first learning rule that may correspond to EIS device 506a, and plot 522 shows a second learning rule that may correspond to EIS device 506b. This result closely resembles, for example, the STDP variations observed in synapses at parallel fiber inputs onto fusiform and cartwheel cells.

While FIG. 5A shows a simplified example having one pre-neuron and two post-neurons, the general concept describe can be scaled up to arbitrary numbers of pre- and post-neurons (e.g., using a crossbar array configuration described below).

Turning to FIG. 5C, according to some embodiments of the present disclosure, EIS can be used in the emulation of dopamine modulated STDP behavior. FIG. 5C shows an example of a local circuit 540 where the pre- and post-synaptic neuron signals (Vₚᵣₑ and Vₚₒₛₜ) are multiplied (scaled) by factors αₚᵣₑ and αₚₒₛₜ, respectively. In some embodiments, operational amplifiers (not shown) can be used to multiply the signals by the factors, and the factors can be controlled (e.g., set) by input and feedback resistors. The scaled signals can then be provided as input to a voltage divider comprising resistors 542, 544 and EIS gate terminal 546, as shown.

The scaling factors αₚᵣₑ and αₚₒₛₜ can be selected to emulate the dopamine level of each neuron. FIG. 5D shows the simulated STDP forms when αₚₒₛₜ is modulated from +1.0 to −1.0 with step 0.2 (graphs 560a-f), while keeping αₚᵣₑ constant as one (1). In this example, the input Vₚᵣₑ and Vₚₒₛₜ waveforms from FIG. 3B are used. The results show that the STDP shape changes from the conventional asymmetric with αₚₒₛₜ=1.0 on the right (graph 560f), to become symmetrical and negative near Δt=0 with αₚₒₛₜ=−1.0 on the left (graph 560a).

Other approaches for emulating dopamine levels can be used. For example, as illustrated in FIGS. 5E and 5F, a third signal related to the dopamine level can be used as a synapse input, along with Vₚᵣₑ and Vₚₒₛₜ.

FIG. 5E shows another local circuit 570, which differs from the STDP circuit of FIG. 3A by the addition of a third voltage input (V_{dopamine}) and an addition resistor in series (R_{dopamine}). The V_{dopamine} in the voltage divider creates a bias on V_{G} to modulate the STDP shape. In some cases, V_{dopamine} can be varied between −4 V and +4 V. In some cases, using the Vₚᵣₑ and Vₚₒₛₜ waveforms of FIG. 3B, R_{dopamine} can be selected to have a resistance equal to fifteen (15) times that of R (the resistors coupled to Vₚᵣₑ and Vₚₒₛₜ). A positive V_{dopamine} skews the conductance modulation towards the positive direction, as it increases the amplitude of the potentiation while reducing the amplitude of depression. If a negative V_{dopamine} is supplied, the STDP is modulated towards the negative direction.

In some cases, V_{dopamine} signal can be generated externally to vary as a function of Δt. In such cases, additional flexibility on the effect of dopamine modulation can be enabled. When a Δt-dependent V_{dopamine} is applied as the additional signal, the shape of the STDP can be switched. In some cases, using the Vₚᵣₑ and Vₚₒₛₜ waveforms of FIG. 3B, R_{dopamine} can be selected to have a resistance equal to 1.5 times that of R (the resistors coupled to Vₚᵣₑ and Vₚₒₛₜ).

In FIG. 5E, the V_{dopamine} signal may depend on Δt and, thus, needs to be generated from an additional circuit that also has information of the firing delay between the pre- and post-synaptic neurons.

FIG. 5F illustrates a circuit 590 for generating a Δt-dependent signal from a Δt-independent V_{dopamine} signal at the synapse circuit using a P-type metal-oxide-semiconductor (PMOS) device 592, a diode 594, and five resistors R1-R5, connected as shown. In some cases, PMOS device 592 may be provided as a SP8M51_P device. In some cases, diode 594 can be chosen as a 1N914 diode. In some cases, R1=R2=R3=R4=10 MΩ and R5=2 MΩ. Using circuit 590, the sign of conductance change at negative Δt can change from negative to positive with increasing V_{dopamine}.

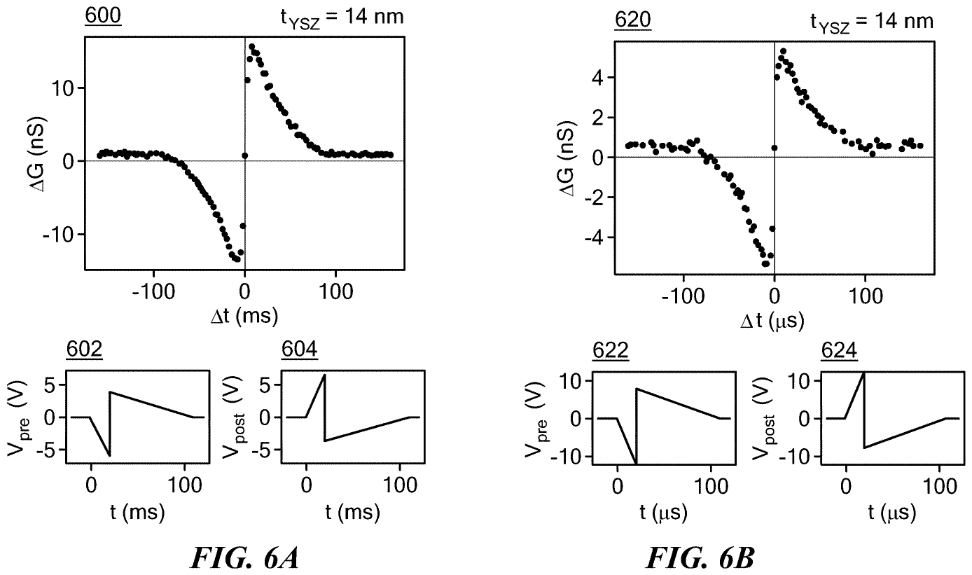

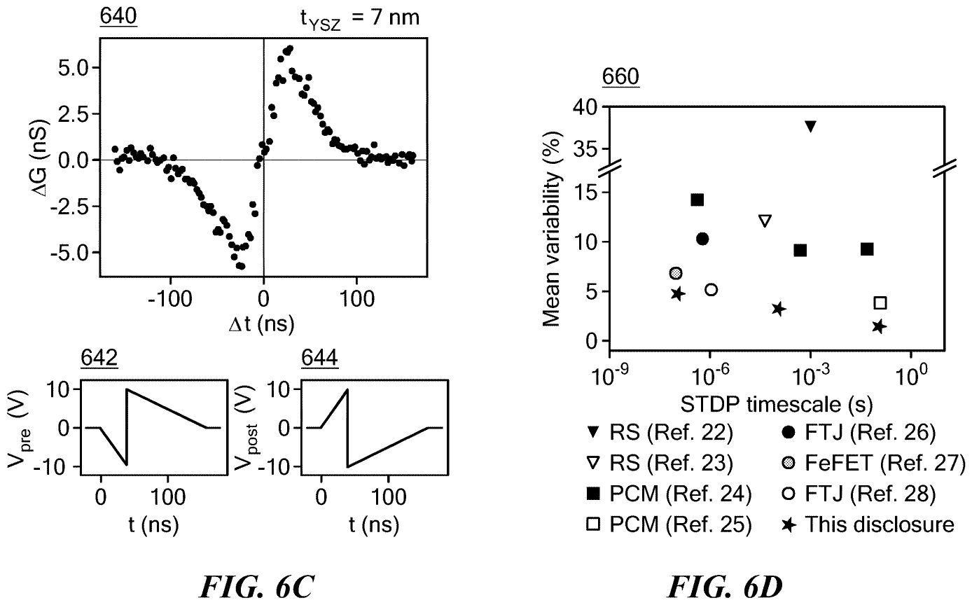

Turning to FIGS. 6A-C, the energy consumption, variability and speed of STDP using disclosed EIS circuits can be important performance characteristics for implementing spiking neural network (SNN) hardware. Disclosed EIS devices and circuits can be leveraged to achieve desired combinations of fast EIS operation speed (down to nanoseconds), low energy consumption, and the intrinsic low variability and deterministic nature of the conductance modulation.

Due to the strong field enhancement of the transport and interfacial reaction kinetics, the timescale of the conductance modulation can be tuned by the voltage amplitudes of the Vₚᵣₑ and Vₚₒₛₜ waveforms, by the thickness of the electrolyte, and by interface chemistry. As shown in FIGS. 6A-C, the canonical STDP behavior is implemented experimentally at timescale ranging from milliseconds to nanoseconds.

In more detail, FIGS. 6A-C show measured STDP with timescales from milliseconds down to nanoseconds. For each time scale, a plot of ΔG vs Δt is shown (plots 600, 620, 640) as well as the waveforms for Vₚᵣₑ (t) and Vₚₒₛₜ (t) (waveforms 602 and 604, 622 and 624, 642 and 644). FIG. 6A shows a time scale regime of 100 ms, with a peak voltage level of 6.5V using a device with a YSZ electrolyte thickness (t_{YSZ}) of 14 nm. FIG. 6B shows a time scale regime of 100 μs, with a peak voltage level of 10 V using a device with t_{YSZ}=14 nm. FIG. 6C shows a time scale regime of 100 ns, with a peak voltage level of 10 V using a device with t_{YSZ}=7 nm.

Millisecond timescales are more relevant for biological systems, and nanosecond timescales enable neuromorphic computing devices that potentially react and learn a million times faster than biological systems.

To assess the variability of the devices, ΔG vs Δt data can be taken, and then the mean absolute difference of the measured ΔG from the smooth curve fitted to the experimental STDP data can be calculated. If the device has no variability, the resulting experimental ΔG vs Δt should follow a smooth curve, because the V_{G} waveform changes smoothly with Δt, and thus we should expect 0 (zero) difference between the measured ΔG and the smooth fitted curve. Any non-zero difference is a measure of the variability among each V_{G} applied to the device at each Δt. This is akin to the cycle-to-cycle variability of memristive device. This metric allows comparison of the variability of disclosed structures and techniques to other non-volatile synaptic devices with published STDP results. The timescales of the STDP can be characterized by the length of voltage waveforms applied.

In FIG. 6D, a plot 660 shows a comparison of variability and STDP timescale, including values calculated based on the ΔG versus Δt data of the devices illustrated by FIGS. 6A-C and extracted from published results. As shown, the disclosed structures and techniques (“This disclosure” in the figure) can consistently achieve lower variability (<5%) at all timescales with the EIS, compared to other mechanisms—resistive switching (RS), phase-change materials (PCM), ferroelectric tunnel junctions (FTJ), and ferroelectric field effect transistors (FeFET)—reported to emulate STDP in the literature.

The energy consumption of the STDP-performing EIS devices can also be estimated. Since no power is needed at rest when there are no spiking events, the idling power consumption is zero for the synapses. The energy associated with electrochemical proton insertion is estimated to be below 1.0 fJ per spiking event, using data for WO₃ intercalation, and by assuming that a peak voltage (10 V) is applied during the whole process. In addition, energy is consumed by the resistors, and the charging and discharging of the capacitance of the EIS gate need to be considered.

The full energy consumption of the circuit can be calculated by integrating the power during the spiking events. In more detail, using an equivalent circuit to FIG. 3A wherein the EIS device is simplified to a capacitor with the electronic capacitance calculated as the parallel plate capacitor, the energy consumption for STDP can be calculated as the integration of the power over the spiking period:

$$E = {\int }_{{t}_{min}}^{{t}_{max}} ( {P}_{p r e} + {P}_{post} ) dt = {\int }_{{t}_{min}}^{{t}_{max}} ( {V}_{p r e} {I}_{p r e} + {V}_{p ost} {I}_{post} ) dt$$

where E is the total energy consumption from a pulse pair, tₘᵢₙ is the starting time of the pulse pair, tₘₐₓ is the ending time of the pulse pair, R is the resistance of both resistors, V_{G} is the voltage at the top electrode of the capacitor, and Pₚᵣₑ and Pₚₒₛₜ are the power consumptions of the voltage source Vₚᵣₑ and Vₚₒₛₜ, respectively. In some cases, the capacitance can be taken as 3.07×10⁻¹⁷ C, and R as 100 MΩ.

The above calculation can be used to show that the energy consumption of each spike event is about 27 to 54 fJ for the STDP behavior shown in FIG. 6C.

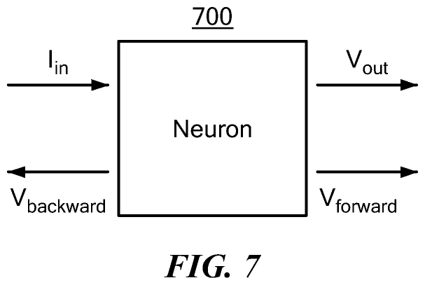

Turning to FIG. 7, the structures and techniques thus described can be used to implement hardware spiking neural networks (SNNs) and analog neural networks (ANNs) based on a crossbar array architecture.

As shown in FIG. 7, an individual neuron 700 can have four terminals: Iᵢₙ, Vₒᵤₜ, V_{backward}, and V_{forward}. Iᵢₙ is an input terminal configured to receive the sum of currents from synapses that connect to it. Vₒᵤₜ is a first output terminal configured to send a signal (e.g., a signal responsive to Iᵢₙ as well as internal dynamics/rules of the neuron) to the next layer through the channel of the EIS in the synapses that connect to it. V_{forward} and I_{backward} are second and third output terminals configured to send voltage waveforms to local circuits (e.g., voltage dividers) of the synapse circuits to apply voltage to the gate for conductance modulations of the EIS channels. Multiple instances of neuron 700 can be provided as pre- and/or post-neurons of a neural network. The neurons can be connected, for example, in a crossbar array as described next.

FIG. 8A shows a crossbar arrangement 800 having one or more pre-neurons connected to one or more post-neurons using an EIS circuit as in FIG. 3A. While only a single pre-neuron 802 and a single post-neuron 804 are illustrated in this figure, the arrangement can generally have an arbitrary number of pre- and post-neurons. The EIS circuit includes an EIS device 806 having source(S), drain (D), and gate (G) terminals and a voltage divider comprising a first resistor R₁ and a second resistor R₂ connected to the gate terminal.

As shown, the pre-neuron's first output terminal

$$( {V}_{o u t}^{p r e} )$$

can be connected to the drain terminal of an EIS device 806 and its second output terminal

$$( {V}_{forward}^{p r e} )$$

connected to the second resistor R₂ of the EIS circuit. The post-neuron's third output terminal

$$( {V}_{backward}^{post} )$$

can be connected to ine urst resistor R₁ of the EIS circuit of an EIS device 806 and its input

$$( {V}_{i n}^{post} )$$

can be connected to the source terminal of the EIS device 806.

FIG. 8B illustrates how the crossbar arrangement 800 of FIG. 8A can be extended to form a crossbar array 820 having an arbitrary number of pre-neurons 822 and post-neurons 824.

The synaptic transmission (signaling from the pre-synaptic neurons to the post-synaptic neurons) can be carried out as follows: the pre-neurons output their activation level as

$${V}_{o u t}^{p r e}$$

and pass the voltage to all synapses connected to the same horizontal line (i.e., row). The current that passes through each synapse is the product of voltage on the D terminal and the conductance of the EIS channel. The current from the synapses in each vertical line (i.e., column) sums up at the

$${I}_{i n}^{post}$$

terminal for each post-neuron. The neurons can be configured to update their internal states and react to the current inputs by generating voltage outputs on their V_{forward}, V_{backward}, and Vₒᵤₜ terminals. The gate voltage of EIS in each synapse is the linear superposition of V_{forward} and V_{backward} lines, and the channel conductance is updated.

The pre-neurons may connect to a previous layer of neurons through another crossbar array of synapses (and serve as the post-neuron there), and the post-neurons may connect further to the next layer of neurons. The first layer of neurons may be sensory neurons that generate output signals according to external excitations or according to data input, and the last layer of neurons may serve as motor neurons to take actions based on the inputs. The neurons in the input layer can have no V_{backward} signal and the neurons in the output layer can have no V_{forward} signal.

For SNNs, Vₒᵤₜ can correspond to the neuron spiking signal that is transmitted to the next layer, while the V_{backward} and V_{forward} can be used to update the conductance of EIS channels. The waveform of the V_{backward} and V_{forward} signal can be designed to implement conductance update rules such as the spike timing dependent plasticity rules using various techniques disclosed herein.

FIG. 9 shows an example of neuron design that implements a leaky integrate-and-fire (LIF) protocol. Illustrative neuron 900 can correspond, for example, to pre-neuron 802 and/or post-neuron 804 of FIG. 8A.

As shown, neuron 900 can include an input terminal (Iᵢₙ) 902 connected to outputs of one or more pre-neurons

$$( {V}_{o u t}^{p r e 1} … {V}_{o u t}^{pre n} )$$

via respective pre-synaptic synapses 940a . . . 940n (940 generally) and summing node 942. The pre-synaptic synapses 940 may be implemented as any of the disclosed EIS devices/circuits, for example.

Neuron 900 also includes an operation amplifier (op amp) 904 having a first input connected to input terminal 902 and a second input connected to receive a reference voltage (V_{ref}) 906. The reference voltage (V_{ref}) may be provided from outside of the neuron 900 and can be 0 V (ground), for example. Of note, the Iᵢₙ depends on this value, because Iᵢₙ is the sum of currents from the all connected synapses, and the current for each synapse is (Vₒᵤₜ−V_{ref}) times the EIS conductance. A capacitor (Cᵢₙₜ) 908 and a resistor (Rₗₑₐₖ) 910 are connected in parallel across the op amp 904. A reset switch (Sᵣₑₛₑₜ) 912 is also connected in parallel with the capacitor 908 and resistor 910. The op amp 904, capacitor 908, and resistor (Rₗₑₐₖ) 910 collectively form a leaky integrator configured to provide an integrated signal 913.

Neuron 900 further includes a comparator 914 (e.g., a voltage comparator) having a first input connected to an output of op amp 904, a second input connected to receive a threshold voltage (Vₜₕ) 916, and configured to generate a trigger signal 917 responsive to a comparison of said inputs. For example, trigger signal 917 can have a first amplitude (e.g., a high voltage) when integrated signal 913 is greater than (or equal to) the threshold voltage (Vₜₕ) 916 and a second amplitude (e.g., a low voltage) when integrated signal 913 is less than the threshold voltage (Vₜₕ) 916. The threshold voltage (Vₜₕ) can be determined by the neuron behavior the circuit aims to emulate. The neuron fires more easily with a lower Vₜₕ. The threshold voltage (Vₜₕ) can be sourced from outside the neuron and adjusted dynamically based on the application, for example.

Neuron 900 also includes three spike generation circuits 918a, 918b, and 918c configured to generate firing waveforms on respective neuron outputs 920a (Vₒᵤₜ), 920b (V_{forward}), and 920c (V_{backward}) in response to trigger signal 917 (e.g., when trigger signal 917 is high). Each of the spike generation circuits 918a-c can be configured to generate a particular firing waveform selected to implement desired STDP forms, with different circuits 918a-c capable of generating different (or similar) waveforms. For example, a given spike generation circuit 918a-c can be configured to generate one or more of the pre- or post-neuron firing waveforms depicted in FIGS. 3B and 4A-D. Spike generation circuits 918a-c can be implemented using waveform generator circuitry, such as one or more digital-to-analogue converters with timers and a pattern memories.

Neuron 900 further includes a timing control circuit 922 having an input connected to receive trigger signal 917 and an output connected to control reset switch 912. For example, when trigger signal 917 is high, timing control circuit 922 can generate a reset signal 924 to have a first amplitude (e.g., a high voltage) causing reset switch 912 to close; and when trigger signal 917 is low, timing control circuit 922 can generate reset signal 924 to have a second amplitude (e.g., a low voltage) causing reset switch 912 to open.

In operation, neuron 900 receives a current from the pre-synaptic synapses 940, which sums up (at node 942) to the current that goes into the Iᵢₙ terminal 902. The current is integrated over time with the integration capacitor (Cᵢₙₜ) 908 and with resistor (Rₗₑₐₖ) 910 for the leaky behavior. The output of the leaky integrator (signal 913) goes to comparator 914 to determine whether the neuron potential reaches the firing threshold set by threshold voltage (Vₜₕ) 916 and generates trigger signal 917 when the voltage from the integrator is above the threshold. The trigger signal 917 goes to the spike generator circuits 918a-c and timing control circuit 922 for the reset switch (Sᵣₑₛₑₜ). The spike generator circuits 918a-c, once triggered, generate firing waveforms as outputs to the Vₒᵤₜ, V_{forward} and V_{backward} terminals. In addition, trigger signal 917 controls control reset switch 912 to reset the integrator voltage to a resting potential (e.g., V_{ref}) after spiking.

In addition to a spiking neural network (SNN), the crossbar array can also be used for the inference and training of an analog neural network (ANN). In this setting, the neuron output Vₒᵤₜ voltage corresponds to the activation level of the neurons in the network. During the inference phase (forward cycle), the Iᵢₙ terminal can receive the summation of current, which equals the activation times the synaptic weight. During the training phase, voltage pulses can be sent from V_{forward} and V_{backward} terminals to induce conductance modulation of each individual synapse in the array. The weight update can be carried out by using the linear voltage superposition and the non-linear behavior of the EIS. Conductance modulation protocols such as pulse coincidence can be used. In some cases, the timing offset of the update waveform can be controlled to achieve time-dependent conductance update for the conductance modulation of the synapses in such an ANN hardware array.

Disclosed embodiments can be applied in energy efficient hardware implementations of neural network, intelligent edge computing devices, miniaturized controller circuit, and can potentially establish an artificial intelligence hardware platform that mimics the principles and operations of biological brains.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A system comprising:
a first neuron configured to generate a first firing waveform;
a second neuron configured to generate a second firing waveform;
an electrochemical ionic (EIS) synapse; and
a circuit electrically connecting the first and second neurons via the EIS synapse and configured to modulate conductivity of the electrical connection provided by the EIS synapse based on relative timing of the first and second firing waveforms.

2. The system of claim 1, wherein the circuit is configured to generate a linear superposition of the first and second firing waveforms.

3. The system of claim 1, wherein the first firing waveform has a first shape and the second firing waveform has a second shape different from the first shape.

4. The system of claim 3, wherein the first shape and the second shape have similar magnitude and opposite polarity.

5. The system of claim 3, wherein the first shape and the second shape are selected to implement a spike-timing-dependent plasticity (STDP) learning rule in the EIS synapse.

6. The system of claim 5, wherein durations of the first and second waveforms are also selected to implement the STDP learning rule.

7. The system of claim 5, wherein the STDP learning rule corresponds to at least one of:
an antisymmetric STDP form;
a long-term potentiation only STDP form; and
a bidirectional symmetric STDP form.

8. The system of claim 1, wherein the EIS synapse includes a first terminal connected to a first output of the first neuron, a second terminal connected to an input of the second neuron, and a gate terminal connected to both a second output of the first neuron and an output of the second neuron.

9. The system of claim 8, wherein the circuit includes voltage divider connecting the second output of the first neuron and the output of the second neuron to the gate terminal of the EIS synapse.

10. The system of claim 1, wherein the EIS synapse includes:
an ion reservoir storing ions to be released upon application of an electrical stimulus;
a channel comprised of one or more materials with tunable electrical conductivity determined by an ion concentration therein; and
an electrolyte disposed between the reservoir and the channel and configured to conduct ions and insulate electrons.

11. The system of claim 1, wherein the first neuron is configured to generate the first firing waveform according to a leaky integrate-and-fire (LIF) protocol.

12. The system of claim 1, wherein the first neuron is one of a plurality of pre-neurons and the second neuron is one of a plurality of post-neurons, wherein the pre- and post-neurons are connected in a crossbar array.

13. The system of claim 12, wherein the pre- and post-neurons are connected to form a spiking neural network (SNN).

14. The system of claim 12, wherein the pre- and post-neurons are connected to form an artificial neural network (ANN).

15. A neural network comprising:
a plurality of pre-neurons;
a plurality of post-neurons; and
a crossbar array having a plurality of electrochemical ionic (EIS) synapses and corresponding local circuits, wherein each of the plurality of EIS synapses and corresponding local circuits electrically connects one of the plurality of pre-neurons to one of the plurality of post-neurons, wherein the local circuits are configured to modulate conductivity of the electrical connection provided by the EIS synapses based on relative timing of pulses generated by the pre-neuron and pulses generated by the post-neuron.

16. The neural network of claim 15, wherein one or more of the local circuits are configured to generate a linear superposition of the pulses generated by the pre-neuron and the pulses generated by the post-neuron.

17. The neural network of claim 15, wherein the pulses generated by the pre-neuron have a first pulse shape and the pulses generated by the post-neuron have second pulse shape different from the first pulse shape.

18. The neural network of claim 17, wherein the first pulse shape and second pulse shape are selected to implement a spike-timing-dependent plasticity (STDP) learning rule in the EIS synapse.

19. The neural network of claim 18, wherein the STDP learning rule corresponds to at least one of:
an antisymmetric STDP form;
a long-term potentiation only STDP form; and
a bidirectional symmetric STDP form.

20. The neural network of claim 15, wherein one or more of the local circuits includes voltage divider.
